(19) United States
(12) Patent Application Publication
(10) Pub. No.: US 2015/0221464 A1
(43) Pub. Date: Aug. 6, 2015

(54) POLE PART OF A MEDIUM VOLTAGE CIRCUIT BREAKER ARRANGEMENT COMPRISING A TRIGGERED GAP UNIT

(71) Applicant: ABB TECHNOLOGY AG, Zurich (CH)

(72) Inventors: Dietmar GENTSCH, Ratingen (DE); Tarek LAMARA, Confignon (CH)

(73) Assignee: ABB TECHNOLOGY AG, Zurich (CH)

(21) Appl. No.: 14/684,886

(22) Filed: Apr. 13, 2015

Related U.S. Application Data
(63) Continuation of application No. PCT/EP2013/003001, filed on Oct. 4, 2013.

(30) Foreign Application Priority Data
Oct. 11, 2012 (EP) 12007043.8

(51) Int. Cl. H01H 33/04; H01H 9/02

(52) U.S. Cl. CPC H01H 33/045; H01H 9/02

(57) ABSTRACT

A pole part of a low-, medium- or high voltage circuit breaker arrangement includes a pole housing for accommodating a vacuum interrupter with a pair of corresponding electrical contacts. A fixed electrical contact is connected to an upper electrical terminal and a movable electrical contact is connected to a lower electrical terminal. The movable electrical contact is operated by a pushrod, and a triggered-vacuum gap or -gas gap or the combination of gas and vacuum gap connected in series is connected in parallel to the electrical contacts in order to avoid contact welding. The triggered vacuum gap or gas gap unit is removably mounted between the upper electrical terminal and the lower electrical terminal is arranged adjacent to the pole housing. Furthermore, the vacuum interrupter device can be triggered directly to protect the vacuum interrupter device from an in-rush current load during the closing operation, for example, during capacitive switching.

### RELATED APPLICATION(S)

This application claims priority under 35 U.S.C. §120 to International application PCT/EP2013/003001 filed on Oct. 4, 2013, designates the U.S., and claims priority to European application 12007043.8 filed on Oct. 11, 2012. The entire content of each prior application is hereby incorporated by reference.

### FIELD

The disclosure relates to a pole part of a low, medium, or high voltage circuit breaker arrangement including a pole housing for accommodating a vacuum interrupter.

### BACKGROUND INFORMATION

Known circuit breaker arrangements with vacuum interrupter inserts accommodated in respective pole parts is usually used in the low- medium- and high-voltage range up 72 kV for load current switching and for occasional short circuit interruption. The current interruption in a vacuum interrupter is realized by contacts separation. During contacts separation an electrical arc burns between the electrical contacts of the vacuum interrupter until the next current zero crossing. The arc extinguished at this moment and the vacuum gap between the electrical contacts becomes insulating which withstand the subsequently recovery voltage across the gap. According to an exemplary embodiment described herein, optimized contact material compositions can be used for high current switching, but they can hardly fulfill the conditions of capacitive switching, such as for the voltage range of 24 kV, 36 kV and higher.

During the making operation, while closing the electrical contacts there is a time period of 1 to maximal 15 ms just before they touch in which the electric field across them becomes high enough to force and at least fire a breakdown. This will give rise to a so called prestrike arc, which will form between the electrical contacts and will carry the power circuit's current. When an arc is initiated between the electrical contacts as they close, a high current will flow through a small contacts spot between the electrical contact surfaces. As the arc persists until the final contact closing, the passage of high current density causes a contact melting at the spot which yields in contacts welding. This effect can be named as “point welding with prearcing under the vacuum atmosphere of the vacuum interrupter”.

For known medium voltage applications used in short circuit current interruption, a standard vacuum circuit breaker fulfills the specification. However, for high performance applications which combine capacitive switching and short circuit current breaking capability, technical problems will arise as described above.

WO 2003/107369 A1 discloses a technical solution for fast and precise switching. The circuit breaker arrangement includes a moveable switching contact which is connected to a drive device that embodies a bi-staple magnetic drive. A triggerable vacuum gap is mounted parallel to the switching contacts. An instrument transformer is serially connected to the triggered vacuum gap whereupon the secondary side thereof is connected to the drive arrangement. The current flowing after the triggering of the triggered vacuum gap in the latter and the parallel current path containing the instrument transformer triggers a switch-on movement of the drive device. The moveable switching contact moves into a closed position. The closed vacuum interrupter receives the current fed to it via triggered vacuum gap unit. The moment of closure of the interrupter insert is determined by the moment when the vacuum gap unit is triggered.

### SUMMARY

An exemplary pole part of a medium voltage circuit breaker arrangement is disclosed, comprising: a pole housing for accommodating a vacuum interrupter insert having a pair of corresponding electrical contacts, the electrical contacts including a fixed electrical contact connected to an upper electrical terminal and a movable electrical contact connected to a lower electrical terminal, wherein the movable electrical contact is operated by a pushrod, and a triggered gap unit is parallel connected to the electrical contacts in order to avoid welding of the contacts in capacitive switching operation, and wherein the triggered gap or multigap unit is removably mounted between the upper electrical terminal and the lower electrical terminal arranged adjacent to the pole housing.

An exemplary pole part of a medium voltage circuit breaker arrangement is disclosed, comprising: a pole housing for accommodating a vacuum interrupter insert with a pair of corresponding electrical contacts, wherein a fixed electrical contact is connected to an upper electrical terminal and a movable electrical contact is connected to a lower electrical terminal and operated by a pushrod, and a triggered vacuum gap unit is inserted at the vacuum interrupter to the electrical contacts in order to avoid welding of the contacts in capacitive switching operation, and wherein the triggered vacuum gap or multigap unit.

### BRIEF DESCRIPTION OF THE DRAWINGS

The foregoing and other aspects of the disclosure will become apparent following the detailed description of the disclosure, when considering in conjunction with the enclosed drawings.

FIG. 1 shows a schematical side view of a pole part of a medium voltage circuit breaker arrangement in accordance with an exemplary embodiment of the present disclosure; and

FIG. 2 shows an inrush current-time-diagram of the circuit breaker arrangement during a closing operation in accordance with an exemplary embodiment of the present disclosure.

### DETAILED DESCRIPTION

Exemplary embodiments of the present disclosure provide a pole part of a medium voltage circuit breaker arrangement which is easily combinable with a standard hermetically sealed triggered vacuum gap or gas-filled spark gap unit. The circuit breaker having a pair of corresponding electrical contacts, wherein a fixed electrical contact is connected to an upper electrical terminal and a movable electrical contact is connected to a lower electrical terminal at the pole housing and operated by a pushrod. An encapsulated triggered gap unit (vacuum gap or pressurized gap unit) is parallel connected to the electrical contacts in order to avoid contacts welding during capacitive switching operation here to take the in-rush current during the closing operation to avoid “point welding of the contact system” under vacuum atmosphere.

According to exemplary embodiments of the present disclosure, a triggered vacuum or gas-filled gap unit is removably mounted between the upper electrical terminal and the lower electrical terminal in a manner that it is arranged adjacent to the pole housing. Furthermore, the triggered vacuum gap can be integrated directly inside the vacuum interrupter itself, here the in-rush current will flow when the contacts are closing but the effect will be finished before the contacts are closed. Under these conditions, the vacuum interrupter is modified and no additional part at the pole part is specified.

Stated differently, the triggered vacuum or gas-filled gap unit or the vacuum interrupter according to the present disclosure is in the both cases an additional electrical device which can be optionally combined with standard pole parts of a medium voltage circuit breaker arrangement in order to provide a sufficient capacitive switching performance.

A triggered vacuum gap unit (TVG) and triggered gas-filled spark gap (TSG) are high-voltage devices for applications where a wide operating voltage range is desired, such as from 300 V to 100 kV or above. The low end of the operation voltage range is independent from the static breakdown voltage (max. DC withstand voltage across the main gap). These devices are commonly used in crowbar circuits for protection against overvoltage conditions. By using a suitable TVG or TSG unit the switching time from the trigger input to the start of main gap current flow decreases at a microsecond level. To avoid the possibility of breakdown in both devices in case the TVG or the TSG will be an additional part parallel to the vacuum interrupter the use of a double gap arrangement will be an advantage. In a double or multigap arrangement, it will not result in a breakdown in the device.

According to an exemplary embodiment of the present disclosure, the triggering vacuum gap or spark gap unit is provided with an upper electrical terminal adapter and a lower electrical terminal adapter each including a first electrical plug for connecting to the corresponding electrical terminals and a second electrical plug for connecting an electrical conductor.

In order to achieve an adapter function it is recommended that the first electrical plug be arranged opposite to the second electrical plug at the triggering vacuum gap or spark gap (or multigap) unit, which provides a compact design for the triggering vacuum gap unit.

Furthermore, the triggering vacuum gap or spark gap (or multigap) unit can include a pair of electrical contacts which are arranged adjacent to one another in a fixed spaced manner inside a vacuum or a gas-filled container. Because the electrical contacts are kept at a fixed distance, there will be no contact welds within the triggered vacuum gap or spark gap (or multigap) unit. Only in case of the direct use of the vacuum interrupter with the additional function as a triggered vacuum gap here the contacts will touch after closing. The electrical contacts of the triggering vacuum gap or spark gap unit can be made of erosion resistance material in case the contact will be not touched.

Once the electrical contacts of the vacuum interrupter insert are closed with no-load or with a very little current, the plasma arc across the electrical contacts of the triggered vacuum gap or spark gap (or multigap) unit will switch off and a welding of the contacts at the electrical contacts of the vacuum interrupter insert is avoided. Consequently, the tips formation at the electrical contacts surface is reduced or suppressed after opening of the contact by breaking the slight weld caused by the closing operation under inrush current load. Switching the capacitive current with the vacuum interrupter insert can be further improved by eliminating or substantially minimizing the restrikes and other breakdowns.

Further technical improvements can be achieved by using inline connection of a resistor and/or inductance and/or NTC-type power thermistor to limit the in-rush current which extends the lifetime of the triggered vacuum gap or spark gap unit. These electrical elements can be arranged between one of the pair of electrical contacts of the triggered vacuum or spark gap (or multigap) unit and one of both electrical terminal adapters.

The triggering of the triggered vacuum gap or spark gap unit can be simply carried out from the beginning of trip signal of the vacuum circuit breaker arrangement itself. The trigger signal can be delayed from the trip signal of the vacuum circuit breaker arrangement because the own time of the vacuum circuit breaker arrangement will be in the range of 30 ms and the inrush current flow will be in the range of 5 ms and maximal up to 15 ms. The triggering of the multigap arrangement has to be made in each compartment. The trigger signal can be inserted in the device or the gap by an electrical impulse or by a laser triggering of the electrically loaded gap of the device.

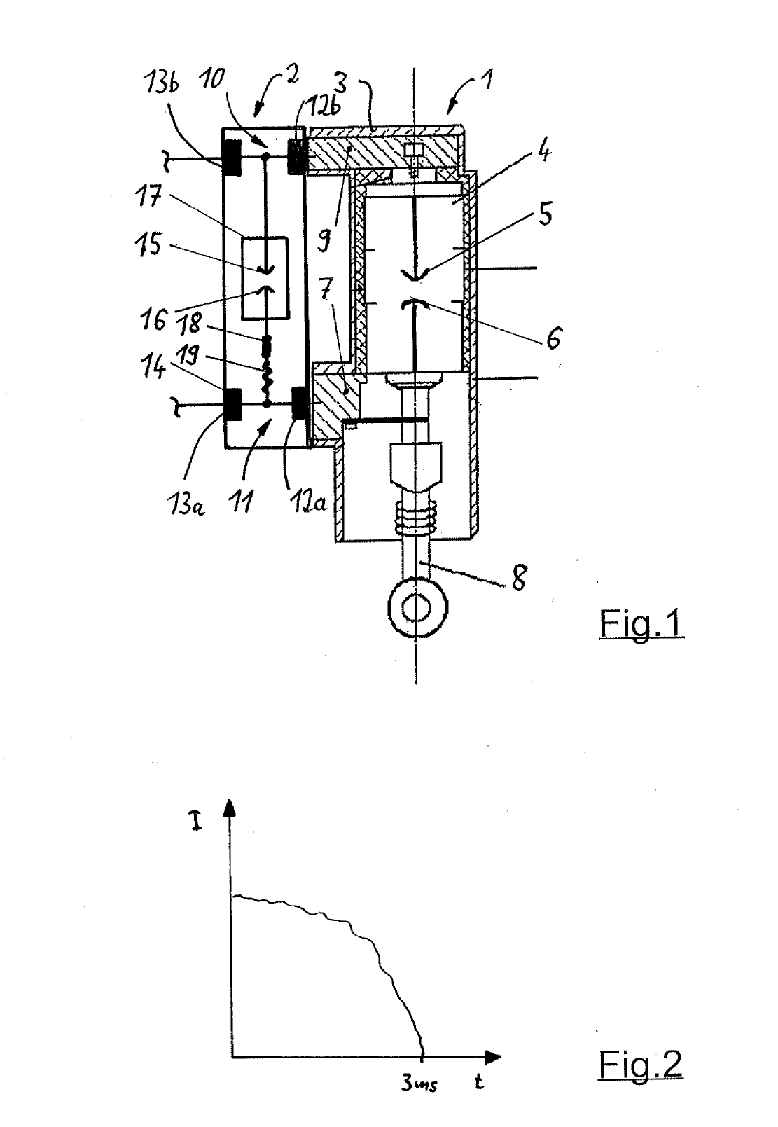

FIG. 1 shows a side view of a pole part of a medium voltage circuit breaker arrangement in accordance with an exemplary embodiment of the present disclosure. As shown in FIG. 1, a medium voltage circuit breaker arrangement can include of a pole part 1 and triggered vacuum gap or spark gap (or multigap) unit 2. The multigap arrangement can be established by a serial connection of vacuum and gas gap or as described above as a vacuum or a gas multigap arrangement. The triggered vacuum gap and/or spark gap (multigap) unit 2 is arranged adjacent to the pole part 1 as an accessory device.

The pole part 1 includes a pole housing 3 made of an epoxy or a thermoplastics material for accommodating a vacuum interrupter 4. The vacuum interrupter insert 4 includes a pair of corresponding electrical contacts 5 and 6. The fixed electrical contact 5 is connected to an upper electrical terminal 9 molded in the pole housing 3. The opposite moveable electrical contact 6 is connected to a lower electrical terminal 7 of the pole housing 3 and is operated by a pushrod 8 for interrupting the current flow through the vacuum interrupter 4.

The triggered vacuum gap or spark gap or the combined gas and vacuum gap (or the single multi vacuum or gas gap) unit 2 is electrically parallel connected to the electrical contacts 5 and 6 of the vacuum interrupter 4 in order to avoid contacts welding (e.g., welding of the contacts) during a closing operation and at a closing position in capacitive switching operation (here the capacitive load as specified in IEC 62271-100).

In order to removable connect the triggered vacuum gap or spark gap or the combined gas and vacuum gap (or the single multi vacuum or gas gap) unit 2 onto the pole part 1 of the medium voltage circuit breaker arrangement, the triggered vacuum gap or spark gap or the combined gas and vacuum gap (or the single multi vacuum or gas gap) unit 2 is provided with an upper electrical terminal adapter 10 and a lower electrical terminal adapter 11, each including a first electrical plug 12a and 12b respectively for connecting to the corresponding electrical terminal 7 and 9, respectively. A second electrical plug 13a and 13b respectively is provided for connecting the triggered vacuum gap or spark gap or the combined gas and vacuum gap (or the single multi vacuum or gas gap) unit 2 to an electrical conductor 14. The first electrical plug 12a; 12b is arranged opposite to the second electrical plug 13a; 13b at the triggered vacuum gap or spark gap or the combined gas and vacuum gap (or the single multi vacuum or gas gap) unit 2.

The triggered vacuum gap or spark gap or the combined gas and vacuum gap (or the single multi vacuum or gas gap) unit 2 includes a pair of electrical contacts 15 and 16 which are arranged in a fixed spaced manner (e.g., fixed space between the contacts) one to another inside a further vacuum or gas-filled container 17 or the combination of vacuum and gas in series arrangement. The pair of electrical contacts 15 and 16 is connected to the upper electrical terminal adapter 10 and the lower electrical terminal adapter 11 respectively. An additional resistor 18 as well and/or as an inductor and/or NTC 19 are arranged between the electrical contact 16 and the lower electrical terminal adapter 11 of the triggered vacuum gap or spark gap or the combined gas and vacuum gap (or the single multi vacuum or gas gap) unit 2. The triggered vacuum gap or spark gap or the combined gas and vacuum gap (or the single multi vacuum or gas gap) unit 2 is automatically activated by a trip signal of the vacuum interrupter 4 of the pole part 1.

FIG. 2 shows an inrush current-time-diagram of the circuit breaker arrangement during a closing operation in accordance with an exemplary embodiment of the present disclosure. As shown in FIG. 2, the inrush current of the medium voltage circuit breaker arrangement decreases rapidly and reaches the nominal current level after 3 or few milliseconds.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SIGNS

1 pole part
2 triggered vacuum gap or spark gap or the combined gas and vacuum gap (or the single multi vacuum or gas gap) unit (TVG)
3 pole housing
4 vacuum interrupter insert
5 fixed electrical contact
6 movable electrical contact
7 lower electrical terminal
8 pushrod
9 upper electrical terminal
10 upper electrical terminal adapter
11 lower electrical terminal adapter
12 first electrical plug
13 second electrical plug
14 electrical conductor
15 electrical contact
16 electrical contact
17 vacuum container
18 resistor
19 inductor

What is claimed is:

1. A pole part of a medium voltage circuit breaker arrangement comprising:
a pole housing for accommodating a vacuum interrupter insert having a pair of corresponding electrical contacts, the electrical contacts including a fixed electrical contact connected to an upper electrical terminal and a movable electrical contact connected to a lower electrical terminal, wherein the movable electrical contact is operated by a pushrod, and a triggered gap unit is parallel connected to the electrical contacts in order to avoid welding of the contacts in capacitive switching operation, and
wherein the triggered gap or multigap unit is removably mounted between the upper electrical terminal and the lower electrical terminal arranged adjacent to the pole housing.

2. The pole part according to claim 1,
wherein the triggered gap unit is provided with an upper electrical terminal adapter and a lower electrical terminal adapter each including a first electrical plug for connecting to the corresponding electrical terminal and a second electrical plug for connecting an electrical conductor.

3. The pole part according to claim 1,
wherein the triggered gap unit includes a pair of electrical contacts, which are arranged one to another in a fixed spaced manner inside a vacuum device.

4. The pole part according to claim 1,
wherein the triggering gap unit includes a pair of electrical contacts, which are arranged one to another in a fixed spaced manner inside a gas-filled container.

5. The pole part according to claim 1,
wherein the triggered gap unit is automatically activated by a trigger pulse generator derived from the trip signal of the vacuum interrupter insert.

6. The pole part according to claim 1,
wherein the triggered gap unit is laser-triggered after a trip signal of the vacuum interrupter in order to achieve bi-directional triggering.

7. The pole part according to claim 1,
wherein the triggered gap unit is disposed in two non-parallel and connected triggering gaps, the triggered gap unit is tripped simultaneously after the trip signal of the vacuum interrupter insert in order to achieve bi-directional triggering.

8. The pole part according to claim 1,
wherein the triggered gap unit has a middle electrode connected to trigger a pulse generator, and the triggered gap unit is tripped after the trip signal of the vacuum interrupter in order to achieve bi-directional triggering.

9. The pole part according to claim 1,
wherein the triggered gap unit is arranged as a multigap arrangement as a vacuum gap or a gas gap or a combination of vacuum and gas.

10. The pole part according to claim 1,
wherein the triggered gap unit is integrated directly in the vacuum interrupter.

11. The pole part according to claim 1,
wherein the triggered gap unit has a combination of resistor and NTC, NTC and inductor, resistor and inductor in series arrangement with the triggered gap unit.

12. A pole part of a medium voltage circuit breaker arrangement comprising:
a pole housing for accommodating a vacuum interrupter insert with a pair of corresponding electrical contacts, wherein a fixed electrical contact is connected to an upper electrical terminal and a movable electrical contact is connected to a lower electrical terminal and operated by a pushrod, and a triggered vacuum gap unit is inserted at the vacuum interrupter to the electrical contacts in order to avoid welding of the contacts in capacitive switching operation, and wherein the triggered vacuum gap or multigap unit.

13. The pole part according to claim 12,
wherein the first electrical plug is opposite arranged to the second electrical plug at the triggered gap unit.

14. The pole part according to claim 13,
wherein the pair of electrical contacts is connected to the upper electrical terminal adapter and to the lower electrical terminal adapter, respectively.

15. The pole part according to claim 13,
wherein a resistor is arranged between one of the pair of electrical contacts and one or both of the electrical terminal adapter.

16. The pole part according to claim 13,
wherein an inductor is arranged between one of the pair of electrical contacts and one or both of the electrical terminal adapters.

17. The pole part according to claim 13,
wherein an NTC-type resistor is arranged between one of the pair of electrical contacts and one or both of the electrical terminal adapters.

18. The pole part according to claim 13,
wherein the triggered gap unit is automatically activated by a second trip signal relatively delayed from the first trip signal of the vacuum interrupter.
